(19) United States
(12) Patent Application Publication
(10) Pub. No.: US 2009/0182505 A1
(43) Pub. Date: Jul. 16, 2009

(54) TRAVELING CONTROL DEVICE OF VEHICLE

(75) Inventor: Kenichi IKEDA, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/326,307

(22) Filed: Dec. 2, 2008

(30) Foreign Application Priority Data
Jan. 16, 2008 (JP) 2008-007352

(51) Int. Cl. G08G 1/16

(52) U.S. Cl. 701/301

(57) ABSTRACT

A traveling control device comprises an obstacle detecting portion to detect an obstacle in front of a vehicle, a dangerous-area setting portion to set a contact-dangerous area with a specified width which is located beside the obstacle which is detected by the obstacle detecting portion, an entry detecting portion to detect an entry of the vehicle into the contact-dangerous area, and a warning control portion to operate a warning device when the entry of the vehicle into the contact-dangerous area is detected by the entry detecting portion. Accordingly, it can be surely prevented that the vehicle approaches the obstacle too close or contacts the obstacle, thereby improving the safety of the vehicle traveling.

### BACKGROUND OF THE INVENTION

The present invention relates to a traveling control device of a vehicle which comprises a means operative to detect an obstacle in front of the vehicle.

Conventionally, a traveling control device which detects an obstacle in front of the vehicle with a sensor, such as a camera or radar, and determines whether the vehicle can pass the obstacle is known.

For example, Japanese Patent Laid-Open Publication No. 08-221698 discloses the obstacle detection device which detects the distance from the vehicle to the front object detected with the image sensor and determines the possibility of the vehicle passing the object.

Generally, two-wheeled vehicles, such as a bicycle or motor bicycle, are not so stable in traveling compared with four-wheeled vehicles, so their traveling condition may becomes unstable when they travel over stones on the road or receive a strong wind.

Accordingly, there is a concern that even if it is detected by the obstacle detection device disclosed in the above-described patent document that the vehicle could pass the obstacle (object), the vehicle would approach the two-wheeled vehicle too close or contact the two-wheeled vehicle improperly.

Further, there occurs a situation in which when the vehicle travels on the road, a door of a vehicle which stops in front of the traveling vehicle is opened abruptly or a pedestrian rushes out from behind the front vehicle. In this situation, there is also a concern that the vehicle would contract the door or the pedestrian and the above-described obstacle detection device could not avoid these accidents.

### SUMMARY OF THE INVENTION

The present invention has been devised in view of the above-described matters, and an object of the present invention is to provide a traveling control device of a vehicle which can surely prevent the vehicle from approaching the obstacle too close or contacting the obstacle improperly, thereby improving the safety of the vehicle traveling.

According to the present invention, there is provided an illumination device of a traveling control device of a vehicle, comprising an obstacle detecting means operative to detect an obstacle in front of the vehicle, a dangerous-area setting means operative to set a contact-dangerous area with a specified width which is located beside the obstacle which is detected by the obstacle detecting means, an entry detecting means operative to detect an entry of the vehicle into the contact-dangerous area set by the dangerous-area setting means, and a warning control means operative to operate a warning means when the entry of the vehicle into the contact-dangerous area is detected by the entry detecting means.

According to the present invention, even in a case in which the detected obstacle becomes unstable or the pedestrian rushes out from behind the obstacle, the vehicle can be surely prevented from approaching the obstacle too close or contacting the obstacle improperly, thereby improving the safety of the vehicle traveling.

According to an embodiment of the present invention, the traveling control device further comprises an obstacle determining means operative to determine whether the obstacle detected by the obstacle detecting means is a two-wheeled vehicle or not, wherein the dangerous-area setting means is configured to set the contact-dangerous area only when it is detected by the obstacle determining means that the obstacle is the two-wheeled vehicle. Thereby, the safety of the two-wheeled vehicle which may be unstable in traveling compared with the four-wheeled vehicle can be improved. Further, since the contact-dangerous area is set only when the two-wheeled vehicle is detected, the safe and smooth traveling of the vehicle can be provided with a reduction of the chance of setting the contact-dangerous area properly.

According to another embodiment of the present invention, the traveling control device further comprises a passing-possibility determining means operative to determine whether the vehicle can pass the obstacle without entering into the contact-dangerous area set by the dangerous-area setting means, wherein the warning control means is configured to further operate the warning means when it is determined by the passing-possibility determining means that the vehicle cannot pass the obstacle without entering into the contact-dangerous area. Thereby, the passenger of the vehicle can be warned of the situation in which the vehicle may not pass the obstacle without entering into the contact-dangerous area before approaching the obstacle, thereby improving the safety of the vehicle traveling, assisting the passenger.

According to another embodiment of the present invention, the traveling control further comprises a braking control means operative to operate a braking means of the vehicle when it is determined by the passing-possibility determining means that the vehicle cannot pass the obstacle without entering into the contact-dangerous area. Thereby, since the braking control means operates the braking means before the vehicle approaches the obstacle, the safety of the vehicle traveling can be improved further by surely preventing the vehicle from approaching the obstacle too close or contacting the obstacle improperly.

According to another embodiment of the present invention, the traveling control further comprises a braking control means operative to operate a braking means of the vehicle when it is determined by the entry detecting means that the entry of the vehicle into the contact-dangerous area is detected. Thereby, since the braking control means operates the braking means even in a case in which the vehicle has entered into the contact-dangerous area, it can be prevented that the vehicle travels along with the obstacle side by side or passes the obstacle in the state in which the vehicle becomes so close to the obstacle.

According to another embodiment of the present invention, the traveling control further comprises an assist means operative to assist the vehicle so that the vehicle travels inside a specified traveling lane and an inside-traveling-lane passing-possibility determining means operative to determine whether the vehicle can pass the obstacle inside the specified traveling lane without entering into the contact-dangerous area set by the dangerous-area setting means, wherein the assist means is configured not to operate when it is determined by the inside-traveling-lane passing-possibility determining means that the vehicle cannot pass the obstacle without entering into the contact-dangerous area. Thereby, since there is provided the assist means which assists the vehicle so that the vehicle travels inside the specified traveling lane, the smooth and safe traveling of the vehicle inside the specified traveling lane can be provided. Herein, the assist means is configured not to operate when it is determined by the inside-traveling-lane passing-possibility determining means that the vehicle cannot pass the obstacle without entering into the contact-dangerous area, so that in a case in which the vehicle cannot pass the obstacle inside the specified traveling lane without entering into the contact-dangerous area, the vehicle can travel passing the obstacle by changing the traveling lane properly.

According to another embodiment of the present invention, the traveling control further comprises a passing determining means operative to determine whether the vehicle has passed the obstacle or not, wherein the assist means is configured to restart an operation thereof when it is determined by the passing determining means that the vehicle has passed the obstacle. Thereby, since the operation of the assist means is automatically restarted after the vehicle has passed the obstacle, the smooth and safe traveling of the vehicle inside the specified lane can be provided without letting the passenger have any troublesome feeling.

Other features, aspects, and advantages of the present invention will become apparent from the following description which refers to the accompanying drawings.

### BRIEF DESCRIPTION OF THE DRAWINGS

FIG. 1 is a perspective view showing a schematic constitution of a vehicle equipped with a drive assist device according to a first embodiment of the present invention.

FIG. 2 is a block diagram showing the constitution of the drive assist device according to the first embodiment.

FIG. 3 is a plan view schematically showing an area of transmission of a radar device and an area of image picked up by a camera.

FIG. 4 is a schematic diagram explaining setting of marking of an object and a contact-dangerous area.

FIG. 5 is a plan view schematically showing relationships between the vehicle and an obstacle.

FIG. 6 is a flowchart showing control processing of a control unit of the drive assist device according to the first embodiment.

FIG. 7 is a block diagram showing the constitution of a drive assist device according to a second embodiment of the present invention.

FIG. 8 is a flowchart showing control processing of a control unit of the drive assist device according to the second embodiment.

### DETAILED DESCRIPTION OF THE INVENTION

Hereinafter, preferred embodiments of the present invention will be described referring to the accompanying drawings.

### Embodiment 1

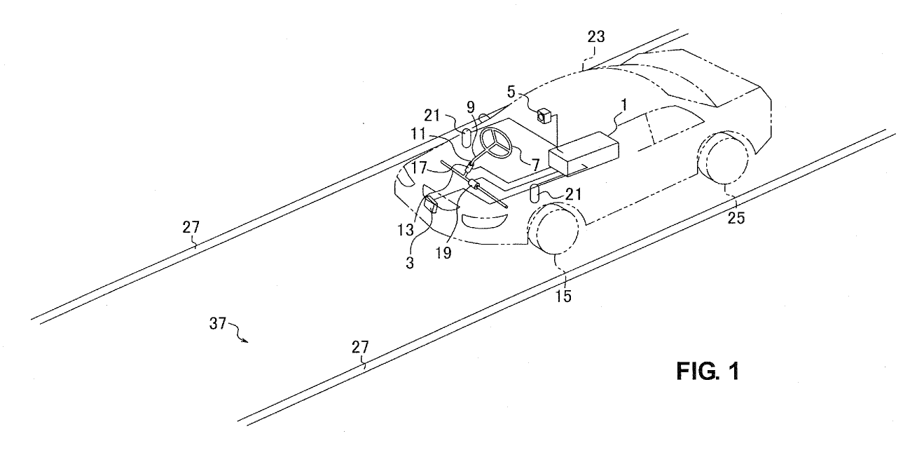

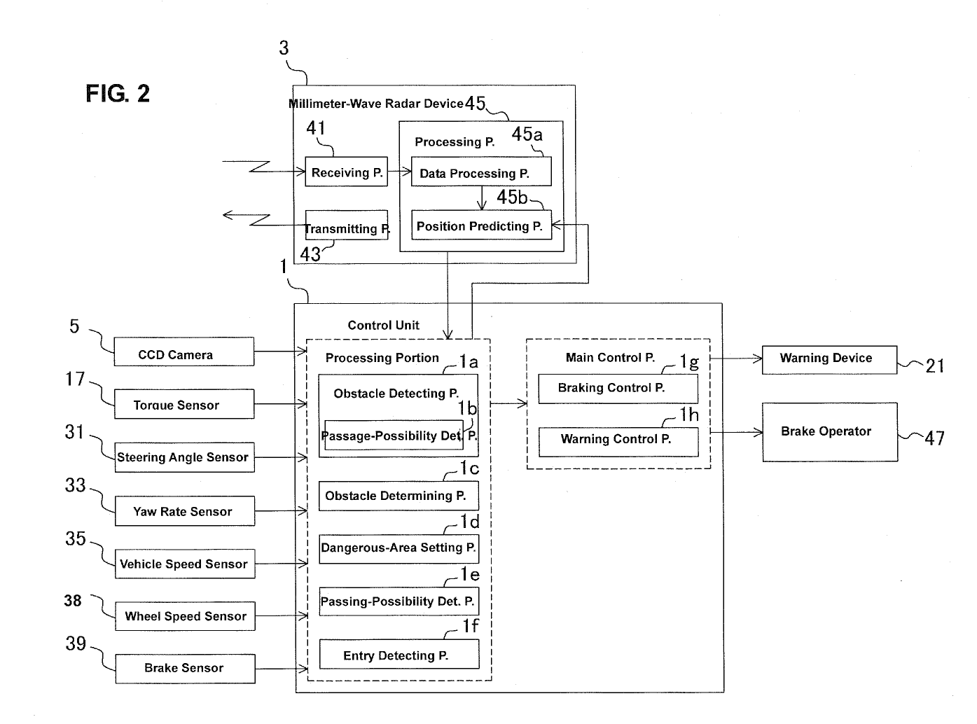

FIG. 1 shows a schematic constitution of a vehicle (an automotive vehicle in the present embodiment) 23 which is equipped with a drive assist device according to the present embodiment. In this figure, reference character 1 denotes a control unit operative to control the drive assist device, reference character 3 denotes an electronic scan type of millimeter-wave radar device operative to detect an object in front of the vehicle 23, which is provided at a front end portion of the vehicle 23, and reference character 5 denotes a CCD camera as a front camera which picks up an image in front of the vehicle 23. The control unit 1 comprises, as shown in FIG. 2, a processing portion which comprises an obstacle detecting portion 1a, an obstacle determining portion 1c, a dangerous-area setting portion 1d, a passing-possibility determining portion 1e and an entry detecting portion 1f, and a main control portion which comprises a braking control portion 1g and a warning control portion 1h. The millimeter-wave radar device 3 and the CCD camera 5 are coupled to the control unit 1 and output related information to the control unit 1.

A steering wheel 7 to be operated by a passenger (driver) of the vehicle 23 has a steering shaft 9 integrally attached thereto, which is coupled to a connection shaft 11 via a universal joint (not illustrated). A rack shaft 13 is coupled to the connection shaft 11 via a rack-and-pinion mechanism (not illustrated). The rotational movement of the steering wheel 7 operated by the passenger is changed to the reciprocating movement of the rack shaft 13 via the steering shaft 9, universal joint, connection shaft 11 and rack-and-pinion mechanism. Thereby, vehicle wheels (front wheels 15, 15) which are coupled to both ends of the rack shaft 13 via tie rods (not illustrated) are steered.

At the connection shaft 11 is provided a torque sensor 17 which detects the steering torque inputted by the operation of the steering wheel 7 by the passenger. The torque sensor 17 is configured to output related information to the steering torque detected to the control unit 1.

Further, as shown in FIG. 2, the vehicle 23 is equipped with a steering angle sensor 31 to detect the steering angle of the steering wheel 7, a vehicle speed sensor 35 to detect the traveling speed of the vehicle 23, a yaw rate sensor 33 to detect the yaw rate of the vehicle 23 and so on. Detection information from the respective sensors is supplied to the control unit 1.

In FIG. 1, reference character 21 denotes a warning device (a speaker as a warning means according to the present embodiment) which warns the passenger of various types of information with sounds. The warning device 21 is control by a warning control portion (corresponding to a warning control means) 1h of the control unit 1.

The millimeter-wave device 3 comprises, as shown in FIG. 2, a transmitting portion 43 which transmits millimeter waves (radar waves) forward scanning a specified-angle range substantially horizontally, a receiving portion 41 which receives reflection waves of the millimeter waves which have reflected on the object in front of the vehicle 23, and a processing portion 45 which executes the detection processing of the object based on data received by the receiving portion.

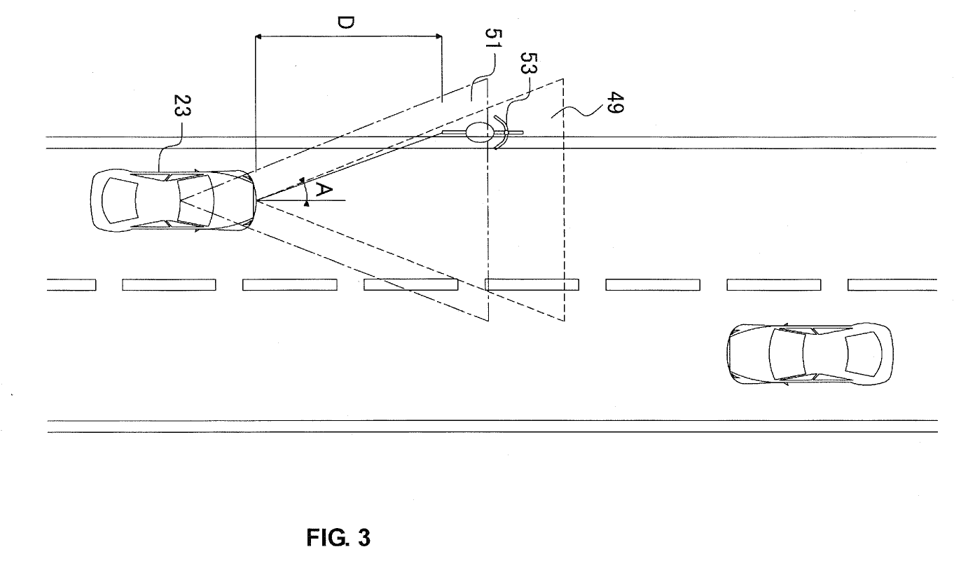

The transmitting portion 43 is configured to transmit the millimeter waves to a predetermined transmission area. As shown in FIG. 3, a transmission area (an area enclosed by a broken line in this figure) 49 is substantially formed in a shape of the isosceles triangle with the vertical angle which is located on the side of the vehicle 23 in the plan view. The width of the transmission area becomes wider gradually forward from the front end of the vehicle 23.

The processing portion 45 comprises a data processing portion 45a which processes the received data for filter processing, the FFT processing and the like, and a position predicting portion 45b which predicts the position of the detected object (automotive vehicle in FIG. 3) 53 in the predetermined specified time (the time equivalent to the scanning time of the millimeter waves) based on the input information of the processed data and the vehicle speed of the vehicle 23 and the like from the control unit 1. The information of the object 53 obtained thereby (the distance D between the object 53 and the vehicle 23, the direction angle A of the object 53 relative to the traveling direction of the vehicle 23, etc.) is supplied to the obstacle detecting portion 1a of the control unit 1.

An area 51 of image picked up by the CCD camera 5 (an area enclosed by a one-dotted broken line in FIG. 3) is substantially formed in a shape of the isosceles triangle with the vertical angle which is located on the side of the vehicle 23 in the plan view. The width of the transmission area becomes wider gradually forward from the center of the upper end portion of a windshield of the vehicle 23. The CCD camera 5 picks up images of any object in front of the vehicle 23, such as parked vehicles, drum cans left at the roadside, two-wheeled vehicles traveling in front. Data of images picked up by the CCD camera 5 is inputted to the obstacle detecting portion 1a of the control unit 1.

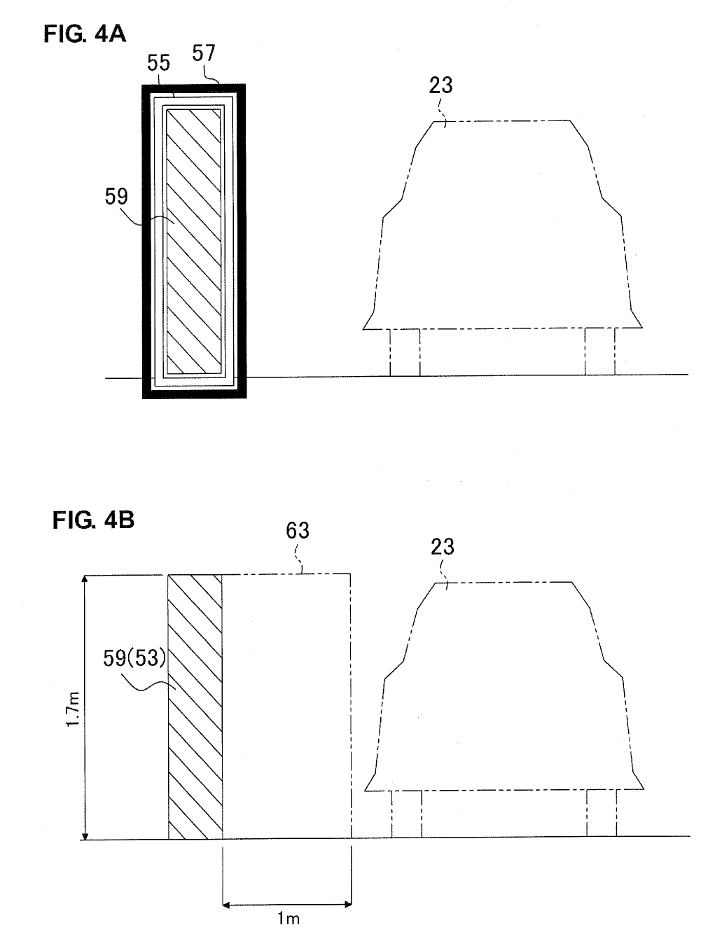

The obstacle detecting portion (obstacle detecting means) 1a detects the obstacle in front of the vehicle 23 from the objects of guide rails, traffic sign poles, four-wheeled vehicles, two-wheeled vehicles and so on based on the input information from the millimeter-wave radar device 3 and the CCD camera 5. More specifically, as shown in FIG. 4A, the obstacle detecting portion 1a sets, for the object existing in front, a first-area frame 55 (illustrated as a white frame in FIG. 4A) which encloses a specified area which is located with its distance D from the vehicle 23 and its location angle A relative to the traveling direction of the vehicle 23 based on the input information from the millimeter-wave radar device 3. Further, the obstacle detecting portion 1a sets a second-area frame 57 (illustrated as a black frame in FIG. 4A) which encloses the object existing in front of the vehicle 23 based on the input information from the CCD camera 5. The first-area frame and the second-area frame are overlapped (fusion) and the marking of object is executed. A marked object 59 (slash portion in FIG. 4) is recognized by the obstacle detecting portion 1a as the object which has a specified size and shape and is positioned at the distance D in front of the vehicle 23 and the angle A relative to the traveling direction of the vehicle 23. Analysis for detecting the obstacle in front of the vehicle 23 is conducted to the marked object 59.

The obstacle detecting portion 1a comprises a passage-possibility determining portion 1b which determines whether or not the vehicle 23 can pass the marked object 59 with keeping its present steering angle (position). More specifically, the passage-possibility determining portion 1b determines whether or not the vehicle 23 can pass the marked object 59 without contacting it by checking the object 59 positioned at the roadside, not at the central portion of the road. This determination of passing possibility is executed at the time of the above-described analysis by the obstacle detecting portion 1a, and the passage-possibility determining portion 1b determines whether the vehicle 23 can pass the marked object 59 based on the position and size of the marked object 59 and the information from the steering angle sensor 31, vehicle speed sensor 35, yaw rate sensor 33 and so on.

When the passage-possibility determining portion 1b determines that the vehicle 23 can pass the marked object 59, the obstacle detecting portion 1a detects the marked object 59 as the obstacle positioned at the roadside (including the sidewalk). The obstacle detection results (the obstacle's size, shape, position on the road, etc.) are inputted to the obstacle determining portion 1c of the control unit 1.

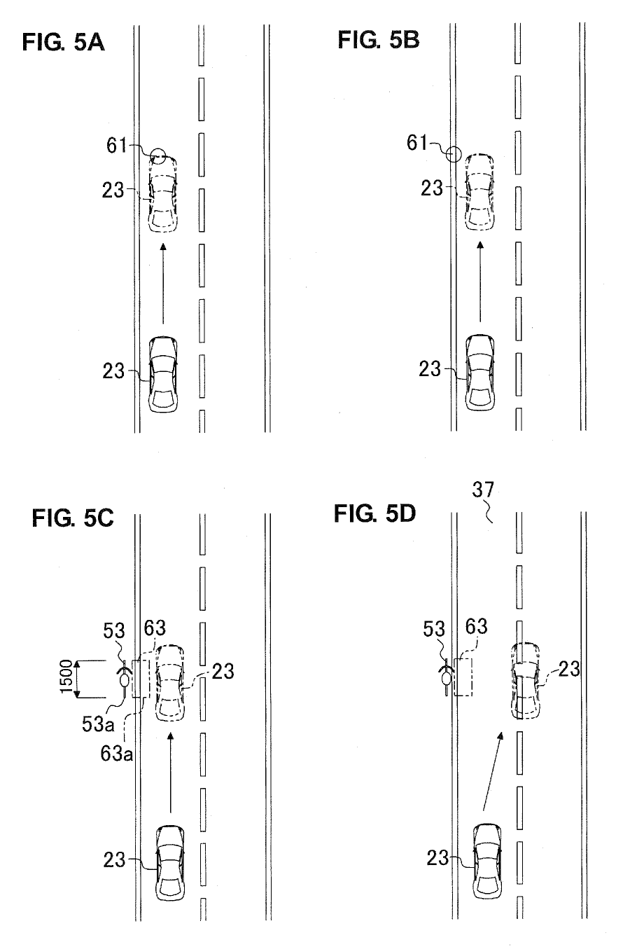

Meanwhile, when the passage-possibility determining portion 1b determines that the vehicle 23 cannot pass the marked object 59, the obstacle detecting portion 1a detects the marked object 59 as the obstacle positioned at the central portion on the road. For example, as shown in FIG. 5A, in a case in which a drum can 61 is left at the central portion on the road, when the passage-possibility determining portion 1b determines that the vehicle 23 cannot pass the marked object 59, the warning control portion 1h operates the warning device 21 to warn the passenger of this impossible-passing situation with a sound (first warning sound) and conducts a pre-crash braking with the braking control portion 1g which will be described later. Herein, the obstacle detecting means of the present invention corresponds to the millimeter-wave radar device 3, CCD camera 5 and the obstacle detecting portion 1a (including the passage-possibility determining portion 1b).

The obstacle determining portion (obstacle determining means) 1c is configured to determine whether or not the obstacle at the roadside detected by the obstacle detecting portion 1a is the two-wheeled vehicle (automotive vehicle, motor cycle, etc.). When the obstacle determining portion 1c determines that the detected obstacle is not the two-wheeled vehicle, the vehicle 23 may travel passing the obstacle because the possibility of the too-close approach or improper contact of the vehicle 23 for the obstacle is properly low. In an example shown in FIG. 5B, the obstacle is the drum can 61 positioned at the roadside, so the vehicle 23 may pass the drum can 61 with keeping the present steering angle of the vehicle 23. Meanwhile, when the obstacle determining portion 1c determines that the detected obstacle is the two-wheeled vehicle, this determination result is inputted to the dangerous-area setting portion 1d of the control unit 1.

The dangerous-area setting portion (dangerous-area setting means) 1d sets the contact-dangerous area (where the vehicle 23 may possibly contact the obstacle) with the specified width (1 m in the present embodiment) which is located by the detected obstacle on the side of the traveling vehicle 23 only when the obstacle determining portion 1c determines that the detected obstacle is the two-wheeled vehicle. In other words, the dangerous-area setting portion 1d is, as shown in FIG. 4B, configured to set the margin of 1 m from the side end of the marked obstacle 59 (obstacle detected by the obstacle detecting portion 1a) on the side of the vehicle 23 (on the right side in FIGS. 4A, 4B) and then set an imaginary area (space) 63 which has the same width as the margin and moves in accordance with the move of the obstacle. Herein, the dangerous-area setting portion 1d sets the contact-dangerous area 63 regardless of whether the two-wheeled vehicle stops or travels.

It is preferable that the contact-dangerous area 63 be configured such that the position of the rear end of this area 63 substantially corresponds to the position of the rear end of the obstacle or extends toward the side of the vehicle 23 (rearward) beyond the rear-end position of the obstacle because the contact-dangerous area 63 means the area where the vehicle 23 may possibly approach the obstacle too close or contact the obstacle. In the example shown in FIGS. 4B and 5C, the contact-dangerous area 63 having the width of 1 m, the length of 1.5 m (the length of the bicycle) and the height of 1.7 m (the height of the bicycle including the passenger) is set for the bicycle 53 with the width of 0.5 m in such a manner that it is positioned on the right of the bicycle 53 and the position of its rear end 63a corresponds to the position of a rear end 53a of the bicycle 53. Thereby, the distance of 1 m is generated between the right-side (the vehicle-road side) end of the bicycle (or the passenger) 53 and the left-side (the sidewalk side) end of the vehicle body of the vehicle 23 when the vehicle 23 passes the bicycle 53. The information related to the contact-dangerous area 63 is inputted to the passing-possibility determining portion 1e from the dangerous-area setting portion 1d.

The passing-possibility determining portion 1e determines whether the vehicle 23 can pass the bicycle 53 detected by the obstacle detecting portion 1a without changing the steering angle by the passenger (with keeping the present traveling direction) and entering into the contact-dangerous area 63 based on the position and size of the contact-dangerous area 63 and the information from the steering angle sensor 31, vehicle speed sensor 35, yaw rate sensor 33 and so on. When the passing-possibility determining portion 1e determines that the passing may be impossible, the warning control portion 1h operates the warning device 21 to warn the passenger of this impossible-passing situation with another waning sound (second warning sound) which is different from the above-described first warning sound, and the braking control portion 1g operates a brake operator (braking means) 47 to conduct the braking to the vehicle 23. The braking control portion (braking control means) 1g is configured to conduct the braking to the vehicle 23 by operating the brake operator 47 to apply brake controls to the front wheels 15, 15 and the rear wheels 25, 25. Meanwhile, when the passing-possibility determining portion 1e determines that the passing may be possible, this determination result is inputted to the entry detecting portion 1f of the control unit 1.

As described above, when the passing-possibility determining portion 1e determines the impossible passing, the traveling control device of the vehicle 23 according to the present invention warns the passenger of this situation with the second warning sound and makes the braking control portion 1g conduct the braking, so that it can be prevented properly that the vehicle 23 enters into the contact-dangerous area 63. Herein, there is a concern that the vehicle 23 would enter into the contact-dangerous area 63 because, for example, the vehicle may be enforced to approach the sidewalk in order to avoid the contact with another vehicle traveling in the opposite lane which comes closer abruptly or on the contrary the bicycle 53 may approach toward the vehicle road abruptly. For this reason, the entry detecting portion (entry detecting means) 1f is configured to detect that the vehicle 23 enters into the contact-dangerous area 63. And, when the entry of the vehicle 23 into the contact-dangerous area 63 is detected by the entry detecting portion 1f, the warning control portion 1h operates the warning device 21 to warn the passenger of this entry with a different sound (third warning sound) from the above-described first and second warning sounds, and the braking control portion 1g operates the brake operator 47 to conduct the braking to the vehicle 23.

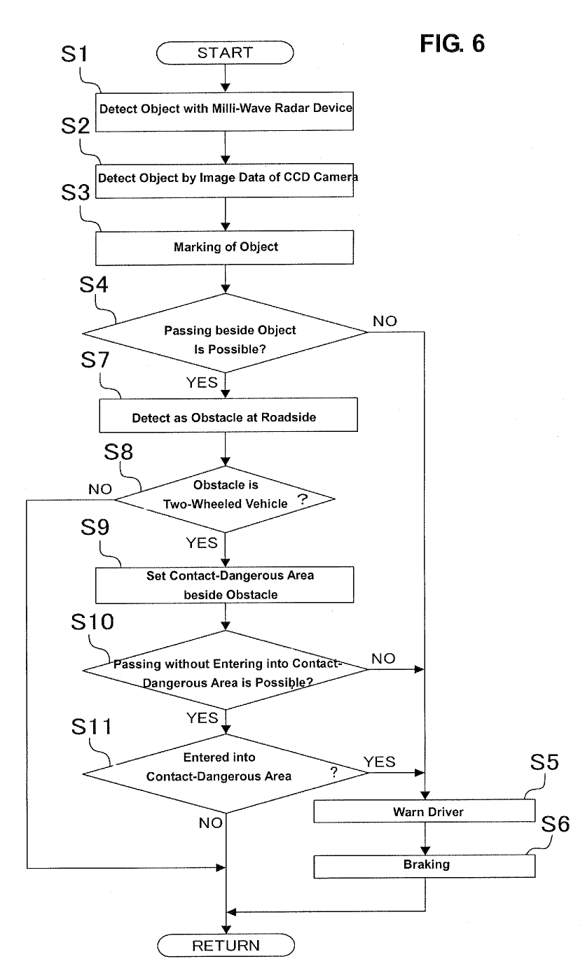

Hereinafter, the processing operations of the control unit 1, the millimeter-wave device 3 and the CCD camera 5 will be described referring to the flowchart of FIG. 6.

In step S1, as described above, the millimeter-wave device 3 transmits the millimeters toward the object in front of the vehicle 23, receives and processes the reflection waves from the object, and thereby obtains the information of the distance D between the object and the vehicle 23 and the direction angle A of the object relative to the traveling direction of the vehicle 23.

In the next step S2, the information on the size and shape of the object in front of the vehicle 23 is obtained based on the data of image picked up by the CCD camera 5.

Then, in step S3, the obstacle detecting portion 1a sets, for the object existing in front, the first-area frame 55 which encloses the specified area which is located with its distance D from the vehicle 23 and its location angle A relative to the traveling direction of the vehicle 23 based on the input information from the millimeter-wave radar device 3 which is obtained in the step S1. Further, the obstacle detecting portion 1a sets the second-area frame 57 which encloses the object existing in front of the vehicle 23 based on the input information from the CCD camera 5 which is obtained in the step S2. And, the first-area frame and the second-area frame are overlapped and the marking of object is executed.

In the next step S4, the passage-possibility determining portion 1b determines whether or not the vehicle 23 can pass the marked object 59 with keeping its present steering angle. When the determination in the step S4 is NO, that is, when the impossible passing is determined by the passage-possibility determining portion 1b, the processing sequence proceeds to step S5, where the warning control portion 1h operates the warning device 21, thereby warns the passenger of this situation of impossible passing of the vehicle 23 beside the marked object with the first warning sound. Then, the processing sequence proceeds to step S6.

In the step S6, the braking control portion 1g operates the brake operator 47 to conduct the braking to the vehicle, and then the processing sequence returns. Then, if the passenger changes the steering angle based on the warning with the first warning sound, the processing operations of the control unit 1 are repeated.

Meanwhile, when the determination is YES in the step S4, the processing sequence proceeds to step S7, where the obstacle detecting portion 1a detects the marked object as the obstacle at the roadside.

In the next step S8, the obstacle determining portion 1c determines whether the obstacle detected by the obstacle detecting portion 1a is the two-wheeled vehicle or not. When the determination in the step S8 is NO, that is, the obstacle determining portion 1c determines that the detected obstacle is not the two-wheeled vehicle, the processing sequence returns simply because the vehicle 23 may travel passing the obstacle with keeping the present steering angle without changing. When the determination in the step S8 is YES, that is, when the obstacle determining portion 1c determines that the obstacle is the two-wheeled vehicle, such as the bicycle or the motor bicycle, the processing sequence proceeds to step S9.

In the step S9, the dangerous-area setting portion 1d sets the contact-dangerous area 63 with the width of 1 m, where the traveling vehicle 23 may possibly contact the bicycle 53. This contact-dangerous area 63 is the imaginary area which is moved in accordance with the move of the bicycle 53, and the position of the rear end 63a of this area 63 substantially corresponds to the position of the rear end 53a of the bicycle 53.

In the next step S10, the passing-possibility determining portion 1e determines whether the vehicle 23 can pass the bicycle 53 without changing the steering angle by the passenger and entering into the contact-dangerous area 63. When the determination in the step S1 is NO, that is, when the passing-possibility determining portion 1e determines that the vehicle 23 cannot pass the bicycle 53, the processing sequence proceeds to step S5, where the warning control portion 1h operates the warning device 21, thereby warns the passenger of this impossible-passing situation with the second waning sound. Then, the processing sequence proceeds to the step S6.

In the step S6, the braking control portion 1g operates the brake operator 47 to conduct the braking to the vehicle 23, and then the processing sequence returns. Then, if the passenger changes the steering angle based on the warning with the second warning sound, the processing operations of the control unit 1 are repeated.

Meanwhile, when the determination in the step S10 is YES, the processing sequence proceeds to step S11, where the entry detecting portion 1f detects whether the vehicle 23 enters into the contact-dangerous area 63 or not. The possible passing has been determined in the step S10, so the vehicle 23 may travel with keeping the present steering angle to pass the bicycle 53. In this case, when the determination in the step S11 is NO, that is, when the vehicle 23 has passed the bicycle 53 without entering into the contact-dangerous area 63, the processing sequence returns.

Meanwhile, when the determination in the step S11 is YES, that is, when the vehicle 23 has entered into the contact-dangerous area 63 by approaching the sidewalk abruptly, the processing sequence proceeds to the step S5, where the warning control portion 1h operates the warning device 21, thereby warns the passenger of this situation of entry into the contact-dangerous area 63 with the third warning sound. Then, the processing sequence proceeds to step S6.

In the step S6, the braking control portion 1g operates the brake operator 47 to conduct the braking to the vehicle, and then the processing sequence returns.

According to the present embodiment, since the contact-dangerous area with the width of 1 m which is located beside the obstacle detected by the obstacle detecting portion 1a is set and the warning device 21 is operated when the entry of the vehicle 23 into the contact-dangerous area 63 is detected, the vehicle 23 can be surely prevented from approaching the obstacle too close or contacting the obstacle, thereby improving the safety of the vehicle traveling.

Also, since the dangerous-area setting portion 1d is configured to set the contact-dangerous area 63 only when it is detected by the obstacle determining portion 1c that the obstacle is the two-wheeled vehicle, the safety of the bicycle 53 as the two-wheeled vehicle which may be unstable in traveling compared with the four-wheeled vehicle can be improved. Further, since the contact-dangerous area 63 is set only when the two-wheeled vehicle is detected, the safe and smooth traveling of the vehicle 23 can be provided with a reduction of the chance of setting the contact-dangerous area 63 properly.

Further, there is provided the passing-possibility determining portion 1e which determines whether or not the vehicle 23 can pass the bicycle 53 without entering into the contact-dangerous area 63 and the warning control portion 1h is configured to further operate the warning device 21 when it is determined by the passing-possibility determining portion 1e that the vehicle 23 cannot pass the bicycle 53, the passenger of the vehicle 23 can be warned of the situation in which the vehicle 23 may not pass the bicycle 53 before approaching the bicycle 53, thereby improving the safety of the vehicle traveling, assisting the passenger.

Also, since the braking control portion 1g operates the brake operator 47 when it is determined by the passing-possibility determining portion 1e that the vehicle 23 cannot pass the obstacle, the brake operator 47 operates before the vehicle 23 approaches the bicycle 53. Accordingly, the safety of the vehicle traveling can be improved further by surely preventing the vehicle 23 from approaching the bicycle 53 too close or improperly contacting the bicycle 53.

Further, since the braking control portion 1g operates the brake operator 47 even in a case in which it is detected by the entry detecting portion 1f that the vehicle 23 has entered into the contact-dangerous area 63, the brake operator 47 operates when the vehicle 23 passes the bicycle 53 even if the vehicle 23 has entered into the contact-dangerous area 63. Accordingly, it can be prevented that the vehicle 23 travels along with the bicycle 53 side by side or passes the bicycle 53 in the state in which the vehicle 23 becomes so close to the bicycle 53.

### Embodiment 2

The present embodiment is different from the above-described first embodiment in providing an assist means operative to assist the vehicle 23 so that the vehicle 23 travels inside a specified traveling lane and a passing determining portion 1i operative to determine whether the vehicle 23 has passed the obstacle or not. Hereinafter, the different constitution from the first embodiment will be described.

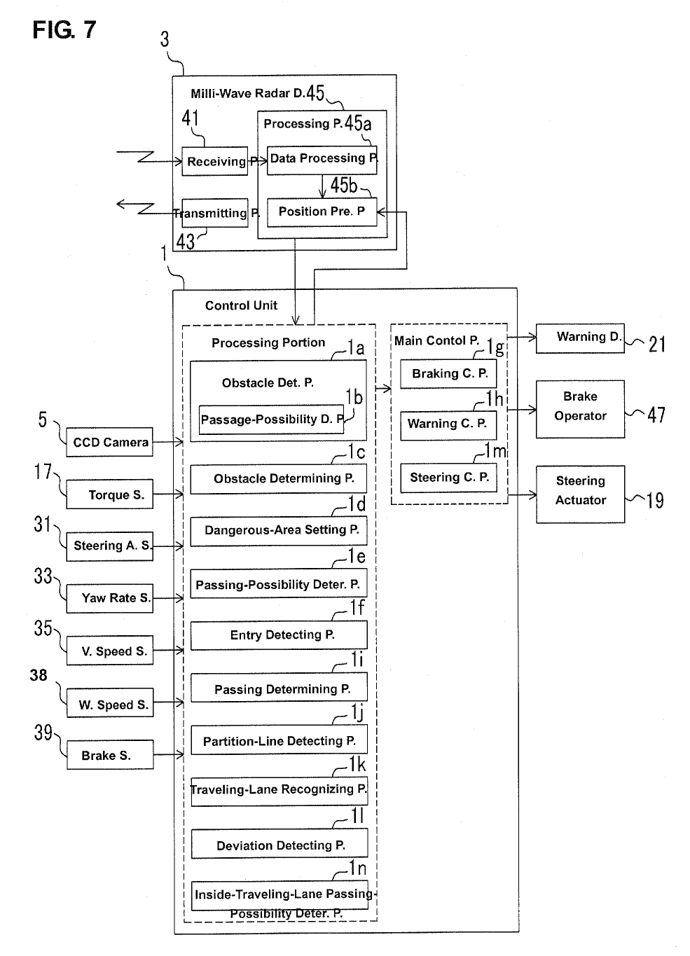

The processing portion of the control unit 1 further comprises, as shown in FIG. 7, a passing determining portion 1i, a partition-line detecting portion 1j, a traveling-lane recognizing portion 1k, a deviation detecting portion 1l and an inside-traveling-lane passing-possibility determining portion 1n, in addition to the above-described obstacle detecting portion 1a, obstacle determining portion 1c, dangerous-area setting portion 1d, passing-possibility determining portion 1e and entry detecting portion 1f. Further, the main control portion of the control unit 1 comprises a steering control portion 1m in addition to the braking control portion 1g and the warning control portion 1h.

The CCD camera 5 picks up images of not only the obstacle in front of the vehicle 23, but various traveling partition lines such as the line for partitioning the traveling lanes, the center line, the border line for separating the vehicle road from the sidewalk. The data of images picked up by the CCD camera 5 is inputted to the partition-line detecting portion 1j of the control unit 1 as shown in FIG. 7. The partition-line detecting portion 1j detects the traveling partition lines such as white lines on the road in front of the vehicle 23 based on the image data. White lines 27, 27 at both sides are recognized in an example of FIG. 1. Detection results of the partition-line detecting portion 1j are inputted to the traveling-lane recognizing portion 1k of the control unit 1, and the traveling-lane recognizing portion 1k recognizes the traveling lanes based on the traveling partition lines detected by the partition-line detecting portion 1j.

In a case in which there exist two traveling partition lines in front of the vehicle 23, the traveling-lane recognizing portion 1k recognizes the inside area between the detected two traveling partition lines as a specified traveling lane. In the example of FIG. 1, when the both-side white lines 27, 27 in front of the vehicle 23 are detected by the partition-line detecting portion 1j, the traveling-lane recognizing portion 1k recognizes the inside area between these white lines 27, 27 as a specified traveling lane 37.

Meanwhile, in a case in which at least one of the traveling partition lines at the both sides is not detected, that is, in a case in which there exists one traveling partition line or no traveling partition line in front of the vehicle 23, the road on which the vehicle 23 is traveling at present is recognized as the specified traveling lane based on the vehicle traveling location (traveling locus) which corresponds to this present road, which is memorized in a memory, not illustrated.

The information on the traveling lane 37 which has been recognized by the traveling-lane recognizing portion 1k is supplied to the deviation detecting portion 1l of the control unit 1, which is configured to detect that the vehicle 23 has deviated from the specified traveling lane recognized or predict this deviation. To the deviation detecting portion 1l are, in addition to the traveling-lane information, inputted the respective information from the torque sensor 17, steering angle sensor 31, yaw rate sensor 33, vehicle speed sensor 35, wheel speed sensor 38 to detect the rotational speeds of the front wheels 15, 15 and the rear wheels 25, 25, brake sensor 39 to detect the brake-pedal operation by the passenger of the vehicle 23, and so on. The deviation detecting portion 1l predicts the lateral position of the vehicle 23 relative to the traveling lane 37 based on the inputted information, thereby detecting that the vehicle 23 has deviated from the traveling lane 37 or predicting this deviation.

When the deviation of the vehicle 23 has been detected or predicted by the deviation detecting portion 1l, this deviation related information of the vehicle 23 is transmitted to the steering control portion 1m of the control unit 1. The steering control portion 1m conducts the traveling control (steering control in the present embodiment) in response to the input of the deviation related information so that the vehicle 23 can travel in the traveling lane 37 which is recognized by the traveling-lane recognizing portion 1k. Specifically, it controls drive of a steering actuator 19 so that the vehicle 23 does not deviate from the specified traveling lane 37 recognized. The steering actuator 19 is provided at the above-described rack shafts 13 so as to make the rack shaft 13 reciprocate. Herein, the brake control by the above-described braking control portion 1g may be applied in place of this steering control, or the both controls may be applied.

Further, when the deviation of the vehicle 23 has been detected or predicted by the deviation detecting portion 1l, this deviation related information is transmitted to the warning control portion 1h as well. The warning control portion 1h operates the warning device 21 in response to the input of the deviation related information so as to warn the passenger of the above-described deviation or its possibility (deviation prediction situation) with another sound (fourth warning sound) which is different from the above-described first, second and third warning sounds. Herein, the assist means operative to assist the vehicle 23 so that the vehicle 23 travels inside the specified traveling lane 37 which is recognized by the traveling-lane recognizing portion 1k of the present invention corresponds to the partition-line detecting portion 1j, traveling-lane recognizing portion 1k, deviation detecting portion 1l, steering control portion 1m, warning control portion 1h, steering actuator 19 and warning device 21.

Herein, there may be a case in which the vehicle could pass the bicycle 53 without entering into the contact-dangerous area 63 by deviating from the traveling lane 37 when the present traveling road has no passing-prohibition section and there is no vehicle on the opposite traveling lanes as shown in FIG. 5D. In this case, it may be preferable that the steering control be cancelled temporarily for allowing a smooth and proper change of the traveling lane of the vehicle 23. Accordingly, the control unit 1 comprises an inside-traveling-lane passing-possibility determining portion (corresponding to an inside-traveling-lane passing-possibility determining means) 1n which determines whether or not the vehicle 23 can pass the obstacle inside the specified traveling lane 37 without entering into the contact-dangerous area 63. The assist means is configured not to operate when it is determined by the inside-traveling-lane passing-possibility determining portion 1n that the vehicle 23 cannot pass the obstacle without entering into the contact-dangerous area 63. Specifically, when it is determined by the inside-traveling-lane passing-possibility determining portion 1n that the vehicle 23 cannot pass the obstacle inside the specified traveling lane 37, the deviation detecting portion 1l does not operate.

The inside-traveling-lane passing-possibility determining portion 1n is configured to determine whether or not the vehicle 23 can pass the bicycle 53 without entering into the contact-dangerous area 63 in a case in which the vehicle 23 changes the steering angle keeping its traveling inside the specified traveling lane 37. When the impossible passing is detected by the above-described passing-possibility determining portion 1e and the impossible passing inside the specified traveling lane 37 is detected by the inside-traveling-lane passing-possibility determining portion 1n, the passenger can be warned of this impossible passing situation in which the vehicle 23 may not pass the bicycle 53 even by changing the steering angle as long as it keeps its traveling inside the specified traveling lane 37 with another sound (fifth warning sound) which is different from the first, second, third and fourth warning sounds. Herein, since the assist means does not operate (the braking is cancelled temporarily) when the passenger tries to change the traveling lane 37 for passing the bicycle 53, this lane change can be conducted smoothly. Further, since the assist means does not operate when the passenger tries to operate the steering for returning to the previous traveling lane 37 after passing the bicycle 53, this lane return can be conducted smoothly.

The determination result of the inside-traveling-lane passing-possibility determining portion 1n and the information on the steering angle of the steering wheel 7 by the steering angle sensor 31 and the like are inputted to the passing determining portion 1l of the control unit 1. The passing determining portion (corresponding to the passing determining means) 1i is configured to determine whether the vehicle 23 has passed the obstacle detected by the obstacle detecting portion 1a or not. Specifically, it is determined whether the vehicle 23 has passed the bicycle 53 by checking whether the bicycle 53 exists in front of the vehicle 23 or not based on the predicted position of the vehicle 23 relative to the bicycle 53, which is calculated based on the traveling speed of the bicycle 53, the traveling speed of the vehicle 23 and the lapse time from the lane changing to the lane return, and the image data of the CCD camera 5. Further, the assist means is configured to restart the steering-angle control, warning control and the like without any switch operation by the passenger when it is determined by the passing determining portion 1i that the vehicle 23 has passed the bicycle 53.

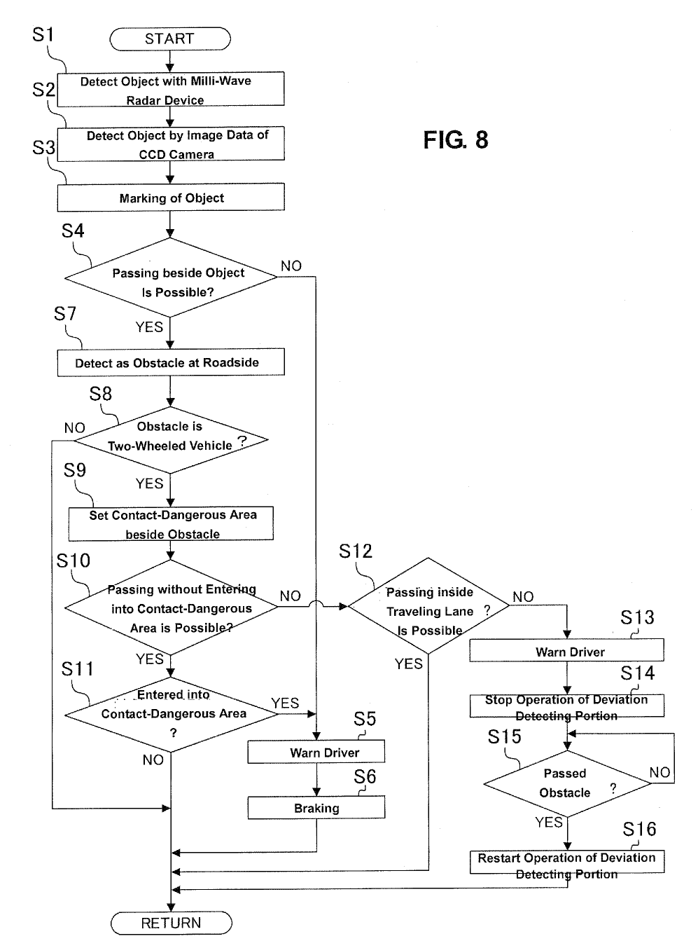

Hereinafter, the processing operation of the control unit 1 will be described referring to the flowchart of FIG. 8. Herein, other steps than the steps S10, S12-S16 in FIG. 8 are the same as those of the flowchart shown in FIG. 6.

When the determination in the step S10 is NO, that is, when it is determined by the passing-possibility determining portion 1e that the vehicle 23 may not pass the bicycle 53 without entering into the contact-dangerous area 63 unless the passenger changes the steering angle, the processing sequence proceeds to the step S12. In the step S12, the inside-traveling-lane passing-possibility determining portion 1n determines whether or not the vehicle 23 can pass the bicycle 53 inside the specified traveling lane 37 without entering into the contact-dangerous area 63. When the determination in the step S12 is YES, that is, when it is determined that the vehicle 23 can pass the bicycle 53 inside the specified traveling lane 37 by changing the steering angle by the passenger, the processing sequence returns. If the passenger changes the steering angle so that the vehicle 23 does not deviate from the traveling lane 37, the processing operation of the control unit 1 is restarted.

Meanwhile, when the determination in the step S12 is NO, that is, when it is determined by the inside-traveling-lane passing-possibility determining portion 1n that the vehicle 23 may not pass the bicycle 53 inside the specified traveling lane 37, the processing sequence proceeds to the step S13, where the warning control portion 1h operates the warning device 21 to warn the passenger of this impossible passing situation with the fifth warning sound. Then, the processing sequence proceeds to the step S14.

In the next step S14, the operation of the deviation detecting portion 1l stops, so that the steering control of the steering control portion 1m stops and the warning device 21 stops. Then, the processing sequence proceeds to the step S15.

In the step S15, the passing determining portion 1i determines whether the vehicle 23 has passed the bicycle 53 or not. When the determination in the step S15 is NO, that is, when it is determined by the passing determining portion 1i that the vehicle 23 has not passed the bicycle 53, the determination of passing by the passing determining portion 1i continues.

Meanwhile, when the determination in the step S15 is YES, that is, when it is determined by the passing determining portion 1i that the vehicle 23 has passed the bicycle 53, the processing sequence proceeds to the step S16, where the operation of the deviation detecting portion 1l is restarted and the steering control is restarted. Then, the processing sequence returns

According to the present embodiment, since there is provided the assist means which assists the vehicle 23 so that the vehicle 23 travels inside the specified traveling lane 37, the smooth and safe traveling of the vehicle 23 inside the specified traveling lane 37 can be provided. Herein, the assist means is configured not to operate when it is determined by the inside-traveling-lane passing-possibility determining portion 1n that the vehicle 23 cannot pass the bicycle 53 inside the specified traveling lane 37 so that in a case in which the vehicle 23 cannot pass the bicycle 53 inside the specified traveling lane 37 without entering into the contact-dangerous area 63, the vehicle 23 can travel passing the bicycle 53 by changing the traveling lane properly.

Also, there is provided the passing determining portion 1i which determines whether or not the vehicle 23 has passed the bicycle 53 which is detected by the obstacle detecting portion 1a, and the assist means is configured to automatically restart its operation when it is determined by the passing determining portion 1i that the vehicle 23 has passed the bicycle 53. Thereby, the smooth and safe traveling of the vehicle 23 inside the specified lane can be provided without making the passenger have any troublesome feeling.

Herein, while the assist means is configured not to operate when it is determined by the inside-traveling-lane passing-possibility determining portion 1n that the vehicle 23 cannot pass the bicycle 53 inside the specified traveling lane 37, it may be configured not to operate when the impossible passing inside the specified traveling lane 37 is determined and the passenger operates the turn signal of the vehicle, for example. In this case, the vehicle 23 can be assisted so as to continue to travel inside the traveling lane 37 when the passenger has no intention to pass the motor cycle and the like.

Further, while the passing determining portion 1i is configured to determine whether or not the vehicle 23 has passed the obstacle detected by the obstacle detecting portion 1a based on the image data of the front camera (CCD camera) 5, it may be configured to make the determination based on data of image of a rear camera which picks up the rear image of the vehicle 23, for example.

Herein, while the dangerous-area setting portion 1d sets the contact-dangerous area 63 when it is determined by the obstacle determining portion 1c that the obstacle detected by the obstacle detecting portion 1a is the two-wheeled vehicle according to the above-described embodiments, setting of the contact-dangerous area 63 may be conducted for the four-wheeled vehicle, not limited to the two-wheeled vehicle. In this case, even in a situation in which a door of another vehicle which stops in front of the vehicle 23 is opened abruptly or a pedestrian rushes out from behind this front vehicle, it can be surely prevented that the vehicle 23 approaches the door or the pedestrian too close or contacts them, thereby improving the safety of the vehicle traveling.

Further, while the millimeter-wave device 3 is applied according to the above-described embodiments, a supersonic-wave sensor may be used, for example. In this case with the sensor operative to detect a non-metal object, the contact-dangerous area 63 may be also set for any human or animal that is positioned at the roadside in front of the vehicle 23, thereby further improving the safety of the vehicle traveling.

The present invention should not be limited to the above-described embodiments, and any other modifications and improvements may be applied in the scope of a spirit of the present invention.

What is claimed is:

1. A traveling control device of a vehicle, comprising:
an obstacle detecting means operative to detect an obstacle in front of the vehicle;
a dangerous-area setting means operative to set a contact-dangerous area with a specified width which is located beside the obstacle which is detected by said obstacle detecting means;
an entry detecting means operative to detect an entry of the vehicle into the contact-dangerous area set by said dangerous-area setting means; and
a warning control means operative to operate a warning means when the entry of the vehicle into the contact-dangerous area is detected by said entry detecting means.

2. The traveling control device of a vehicle of claim 1, further comprising an obstacle determining means operative to determine whether the obstacle detected by said obstacle detecting means is a two-wheeled vehicle or not, wherein said dangerous-area setting means is configured to set the contact-dangerous area only when it is detected by the obstacle determining means that the obstacle is the two-wheeled vehicle.

3. The traveling control device of a vehicle of claim 1, further comprising a passing-possibility determining means operative to determine whether the vehicle can pass the obstacle without entering into the contact-dangerous area set by said dangerous-area setting means, wherein said warning control means is configured to further operate the warning means when it is determined by the passing-possibility determining means that the vehicle cannot pass the obstacle without entering into the contact-dangerous area.

4. The traveling control device of a vehicle of claim 3, further comprising a braking control means operative to operate a braking means of the vehicle when it is determined by the passing-possibility determining means that the vehicle cannot pass the obstacle without entering into the contact-dangerous area.

5. The traveling control device of a vehicle of claim 1, further comprising a braking control means operative to operate a braking means of the vehicle when it is determined by said entry detecting means that the entry of the vehicle into the contact-dangerous area is detected.

6. The traveling control device of a vehicle of claim 1, further comprising an assist means operative to assist the vehicle so that the vehicle travels inside a specified traveling lane and an inside-traveling-lane passing-possibility determining means operative to determine whether the vehicle can pass the obstacle inside the specified traveling lane without entering into the contact-dangerous area set by said dangerous-area setting means, wherein said assist means is configured not to operate when it is determined by the inside-traveling-lane passing-possibility determining means that the vehicle cannot pass the obstacle without entering into the contact-dangerous area.

7. The traveling control device of a vehicle of claim 6, further comprising a passing determining means operative to determine whether the vehicle has passed the obstacle or not, wherein said assist means is configured to restart an operation thereof when it is determined by said passing determining means that the vehicle has passed the obstacle.
